(19) United States
(12) Patent Application Publication
(10) Pub. No.: US 2020/0257139 A1
(43) Pub. Date: Aug. 13, 2020

(54) SPATIALLY RESOLVED COUNTER-COLORING

(71) Applicant: Rodenstock GmbH, Muenchen (DE)

(72) Inventor: Klaus Dahmen, Eresing (DE)

(21) Appl. No.: 16/480,414

(22) PCT Filed: Jan. 3, 2018
(86) PCT No.: PCT/EP2018/050143

§ 371 Date: Sep. 19, 2019

(30) Foreign Application Priority Data
Jan. 26, 2017 (DE) 10 2017 000 698.9

(51) Int. Cl. G02C 7/10; C03C 17/00; G01J 3/46

(52) U.S. Cl. CPC G02C 7/108; G01J 3/463; C03C 17/001

(57) ABSTRACT

The present invention relates to improved coloring of an optical glass, in particular of a spectacle lens, comprising a predetermined glass material, in order to obtain a target coloration of the optical glass. In this case, a method according to the invention comprises: determining a material-specific intrinsic coloration of the predetermined glass material; determining a glass thickness at a plurality of evaluation locations on the optical glass; identifying an intrinsic coloration of the optical glass from the material-specific intrinsic coloration of the predetermined glass material and the glass thickness at the plurality of evaluation locations on the optical glass; determining a reference color pigment amount for at least one color pigment in such a way that the reference color pigment amount applied on a reference substrate brings about for the reference substrate the target coloration to be obtained on the optical glass; specifying a color correction model which describes a relationship between a deviation of a color pigment amount for at least one color pigment from the reference color pigment amount of the at least one color pigment and a resultant deviation of a coloration of the reference substrate from the target coloration; and determining a target color pigment amount which deviates from the reference color pigment amount by a color pigment amount correction which compensates for the ascertained intrinsic coloration of the optical glass in accordance with the defined color correction model.

The present invention relates to the coloring of optical glasses, in particular spectacle lenses, with an improved approximation to a target coloration to be obtained.

Spectacle lenses are often produced with or from plastic materials. These plastic materials may have an intrinsic coloration, with different shades being possible depending on the material and thickness (e.g., gray, yellow, or blue). Especially the thickness of a spectacle lens can significantly influence the resulting color impression or its intensity. Here, the thickness varies across a spectacle lens, which due to the intrinsic coloration of the spectacle lens material can lead to a position-dependent or direction-of-sight-dependent color impression for the spectacle wearer. Especially with colored or tinted glasses, this intrinsic coloration can be perceived as very disturbing. If the target coloration is light blue and the intrinsic coloration of the glass material is yellow, then a range of green to blue partial colorations can arise across the glass.

Occasionally, an attempt is made to compensate for the influence of the intrinsic coloration of a plastic material by adding other color components to the bulk material of the plastic or by moving it into a spectrally less sensitive area for the eye. For example, in the case of materials that have a strong yellow index, i.e. which appear to be yellowish to the eye, so-called “blueing agents” are occasionally used. Generally speaking, by using complementary colors in the bulk material, a shift into the neutral gray area is possible. However, a removal of the entire effect is not obtained. Thus, for example, the addition of a “blueing agent” shifts the material-thickness-dependent yellow shift to the benefit of graying. Thus, the thickness-dependent discoloration is preserved in principle.

The object of the invention is to improve the control of the resulting overall coloration of a spectacle lens even when using a wide variety of plastics for the spectacle lens and most varied geometries or optical effects of the spectacle lens. This object is obtained by a method including the features specified in claim 1, a system including the features specified in claim 12 and a computer program product including the features specified in claim 14. Preferred embodiments are subject of the dependent claims.

Thus, in one aspect, the invention relates to a method of coloring an optical glass, in particular a spectacle lens, which comprises a predetermined glass material. In particular, the optical glass can be made of the predetermined glass material. In this case, a target coloration of the optical glass is to be obtained. The target coloration may be homogeneous coloration, i.e. uniform throughout the entire glass. In another embodiment, however, the coloration may also define a color transition or color gradient. For example, in the case of a spectacle lens, it may be desirable to have a darker color at the top than at the bottom section.

The method comprises determining a material-specific intrinsic coloration of the predetermined glass material. The intrinsic coloration of the predetermined glass material can be composed of effects on the surface of the glass material and of effects in the interior, i.e. in the bulk, of the glass material. For example, a material-specific intrinsic coloration of the predetermined glass material could be described by an intrinsic color vector \vec{F}(d):=\vec{F₀}+d·\vec{D} with a surface color vector \vec{F₀} and a volume color vector \vec{D} at a glass thickness d.

In addition, the method includes determining a glass thickness at a plurality of evaluation points on the optical glass. Thus, a location-dependent glass thickness of the optical glass is determined. This can be done in different ways. In a preferred embodiment, the glass thickness can be measured, for example, immediately before coloring. However, it is particularly preferred for the determination of the location-dependent glass thickness to take place at a plurality of evaluation points on the optical glass on the basis of data sets of an optical calculation and optimization method of at least one glass surface of the optical glass. Thus, for optical glasses, in particular spectacle lenses, data sets about the distribution of the optical properties across the spectacle lens or about the profile and shape of the surfaces as well as data on the location-dependent glass thickness are often available from glass production, in particular if the spectacle lens has been calculated and optimized (individually).

The method further comprises identifying a (location-dependent) intrinsic coloration of the optical glass from the material-specific intrinsic coloration of the predetermined glass material and the (location-dependent) glass thickness at the plurality of evaluation points on the optical glass. While any surface effects of an intrinsic coloration are preferably substantially constant throughout the entire optical glass, volume effects are particularly dependent on the thickness of the predetermined glass material. In the case of a location-dependent thickness, this thickness-dependent intrinsic coloration thus leads to a possibly inhomogeneous, i.e. location-dependent intrinsic coloration of the optical glass.

Furthermore, the method comprises determining a reference color pigment amount for at least one color pigment (particularly preferably for at least three different color pigments) such that the reference color pigment amount, applied to a reference substrate, causes the target coloration to be obtained on the optical glass for the reference substrate. In particular, a corresponding reference color pigment amount is determined for each color pigment used in the coloring process. With these reference color pigment amounts, the reference substrate obtains the target coloration actually to be obtained on the optical glass. The reference color pigment amounts can be determined once in advance experimentally for each target coloration to be obtained and then stored in a database. On the basis of such a database, new target colorations can be calculated e.g. by interpolation from existing data.

In a preferred embodiment, a substrate that is as transparent and/or color-neutral as possible could be used as a reference substrate. In particular in this case can the entire color of the optical glass (before the coloring process) be used or determined as the identified intrinsic coloration of the optical glass. Alternatively, in particular if a substrate that is not completely transparent and/or color-neutral is used as the reference substrate, a deviation of the coloration of the optical glass (before the coloring process) from the intrinsic coloration of the reference substrate can be used as the intrinsic coloration of the optical glass. In particular, since many color pigments can behave differently on different materials, e.g. cause different colorations, it is particularly preferred in practice that the material of the reference substrate correspond to the predetermined glass material. Thus, the optical glass to be colored and the reference substrate are substantially match at least with respect to surface effects of the intrinsic coloration. The remaining parts of a difference in the intrinsic coloration are mainly due to bulk effects and thus to the (location-dependent) glass thickness of the glass to be colored.

Considering the reference substrate, determining the location-dependent glass thickness at a plurality of evaluation points on the optical glass particularly preferably comprises identifying a deviation Δd of the location-dependent glass thickness of the optical glass at a plurality of evaluation points on the optical glass from a thickness of the reference substrate. Here, identifying the location-dependent intrinsic coloration of the optical glass particularly preferably comprises identifying a deviation Δ\vec{F} of an intrinsic coloration of the optical glass from an intrinsic coloration of the reference substrate on the basis of the identified deviation Δd of the position-dependent glass thickness of the optical glass from a thickness of the reference substrate according to

Δ\vec{F}=Δd·\vec{D}

with a volume color vector \vec{D}. In addition, if a thickness of the reference substrate is chosen which is equal to or near an average value of a thickness of optical glasses to be colored, (local) deviations of the intrinsic coloration of the optical glass to be colored from the intrinsic coloration of the reference substrate are small. Thus, a correspondingly small correction of the color pigment amount to be applied (also as the target color pigment amount) with respect to the (respective) reference color pigment amount is necessary. For very small corrections, preferred linear color correction models described below are still very accurate.

The method further comprises specifying a color correction model describing a relationship between a deviation of a color pigment amount for at least one color pigment from the reference color pigment amount of the at least one color pigment and a resulting deviation of a coloration of the reference substrate from the target coloration.

This relationship is preferably described in a color space considered to be particularly suitable for the respective application. The L*a*b* color space (CIELAB) according to EN ISO 11664-4 is chosen below by way of example. However, the invention can also be used with other color space models, e.g. RGB color space, CMYK color space, etc.

Particularly preferably, a linear color correction model is specified. Specifically, specifying the color correction model comprises determining a pigment amount correction matrix [symbol] such that the relationship between a deviation Δ\vec{P}=\vec{P}−\vec{Pᵣ} of a color pigment amount \vec{P} for at least one color pigment from the reference color pigment amount \vec{Pᵣ} of the at least one color pigment and a resulting deviation Δ\vec{Z}=\vec{Z}−\vec{Z_{z}}\vec{ } of a coloration \vec{Z} of the reference substrate from the target coloration \vec{Z_{z}} is described by

Δ\vec{P}= [symbol] ·Δ\vec{Z}

In this case, \vec{P} represents a color pigment amount vector whose entries (components) represent the respective amount of different color pigments. Thus, if 3 different color pigments are used, \vec{P} preferably forms a 3-dimensional vector. \vec{Z} represents a coloring vector whose entries (components) correspond to the coordinates of the selected color space. Particularly preferably, the pigment amount correction matrix [symbol] is determined experimentally on the reference substrate. For this purpose, the amount of pigment of the different color pigments can be varied and the resulting color can be measured. Especially if a linear color correction model is used is the experimental determination of matrix entries with only a few measurement points of slightly different coloration and color pigment amounts on the reference substrate possible in a quite precise way.

Finally, the method comprises determining a target color pigment amount that deviates from the reference color pigment amount by a color pigment amount correction, which compensates for the identified intrinsic coloration of the optical glass according to the specified color correction model. For example, determining a target color pigment amount \vec{P_{z}} can be performed according to

\vec{P_{z}}=\vec{Pᵣ}− [symbol] ·Δ\vec{F}

As far as the intrinsic coloration of the optical glass changes due to the location-dependent glass thickness across the optical glass, a very efficient compensation of this undesirable effect by a location-dependent color pigment amount correction is obtained with the method according to the invention. This corrected color pigment amount (target color pigment amount) can then be applied to at least one surface of the optical glass. This gives the glass to be colored the desired target coloration, even with very different glass thicknesses and always with a very good approximation across the entire glass surface. The invention can be applied to homogeneous colorations and color transitions (e.g., bi-color colorations) both in a simple and effective way. Even with very strong optical powers (strong plus or minus powers or strong prisms) can unwanted deviations from the coloration to be obtained be suppressed very efficiently.

In a preferred embodiment, the target coloration T; to be obtained for the optical glass can be described according to

\vec{Z_{z}}(\vec{x})=I(\vec{x})·\vec{Z_{O,z}}+(1−I(\vec{x}))·\vec{Z_{U,z}}

so that it depends on a position \vec{x} on the optical glass with a first target coloration \vec{Z_{O,z}} to be obtained at a first evaluation point \vec{x_{O}} on the optical glass, a second target coloration \vec{Z_{U,z}} to be obtained at a second evaluation point \vec{x_{U}} on the optical glass, and a preferably continuous interpolation function I(\vec{x}) satisfying I(\vec{x_{O}})=1 and I(\vec{x_{U}})=0.

Preferably, determining the reference color pigment amount comprises:
determining a first reference color pigment amount \vec{P_{O,r}} such that the first reference color pigment amount \vec{P_{O,r}}, applied to the reference substrate, causes the first target coloration \vec{Z_{O,z}} to be obtained on the optical glass for the reference substrate; and
determining a second reference color pigment amount \vec{P_{U,r}} such that the second reference color pigment amount \vec{P_{U,r}}, applied to the reference substrate, causes the second target coloration \vec{Z_{U,z}} to be obtained on the optical glass for the reference substrate.

In particular, specifying a color correction model comprises:
determining a first pigment amount correction matrix [symbol] such that the relationship between a first deviation Δ\vec{P_{O}}=\vec{P_{O}}−\vec{P_{O,x}} of a first color pigment amount FY, for at least one color pigment from the first reference color pigment amount \vec{P_{O,r}} of the at least one color pigment and a resulting first deviation Δ\vec{Z_{O}}=\vec{Z_{O}}−\vec{Z_{O,z}} of a first coloration \vec{Z_{O}} of the reference substrate from the first target coloration \vec{Z_{O,z}} is described by

Δ\vec{P_{O}}= [symbol] ·Δ\vec{Z_{O}}; and
determining a second pigment amount correction matrix [symbol] such that the relationship between a deviation Δ\vec{P_{U}}=\vec{P_{U}}−\vec{P_{U,x}} of a second color pigment amount \vec{P_{U}} for at least one color pigment from the second reference color pigment amount \vec{P_{U,r}} of the at least one color pigment and a resulting second deviation Δ\vec{Z_{U}}=\vec{Z_{U}}−\vec{Z_{U,z}} of a second coloration \vec{Z_{U}} of the reference substrate from the second target coloration \vec{Z_{U,z}} is described by

Δ\vec{P_{U}}= [symbol] ·Δ\vec{Z_{U}}

More preferably, determining a target color pigment amount comprises:
determining a first target color pigment subset \vec{P_{O,k}} according to

\vec{P_{O,z}}=\vec{P_{O}}− [symbol] ·Δ\vec{F};
determining a second target color pigment subset \vec{P_{U,k}} according to

\vec{P_{U,z}}=\vec{P_{U}}− [symbol] ·Δ\vec{F};

and
determining the target color pigment amount \vec{P_{z}} according to

\vec{P_{z}}=I(\vec{x})·\vec{P_{O,z}}+(1−I(\vec{x}))·\vec{P_{U,z}}

In a further aspect, the invention relates to a corresponding coloring system for coloring an optical glass, in particular a spectacle lens, which comprises a predetermined glass material, for obtaining a target coloration of the optical glass, the system comprising:
a glass material data module for determining a material-specific intrinsic coloration of the predetermined glass material;
a glass thickness module for determining a (location-dependent) glass thickness at a plurality of evaluation points on the optical glass;
an intrinsic coloration identification module for identifying a (location-dependent) intrinsic coloration of the optical glass from the material-specific intrinsic coloration of the predetermined glass material and the (location-dependent) glass thickness at the plurality of evaluation points on the optical glass;
a reference module for determining a reference color pigment amount for at least one color pigment (particularly preferably for at least three different color pigments) such that the reference color pigment amount, applied to a reference substrate, causes the target coloration to be obtained on the optical glass for the reference substrate;
a color correction model module for specifying a color correction model that describes a relationship between a deviation of a color pigment amount for at least one color pigment from the reference color pigment amount of the at least one color pigment and a resulting deviation of a coloration of the reference substrate from the target coloration; and
a target color pigment amount module for determining a target color pigment amount that deviates from the reference color pigment amount by a color pigment amount correction, which compensates for the identified intrinsic coloration of the optical glass according to the specified color correction model.

Preferably, the coloring system further comprises a color pigment application module for applying the target color pigment amount to at least one surface of the optical glass. The coloring system is particularly preferably designed to carry out a method for coloring an optical glass described herein, in particular according to one of the preferred embodiments described herein.

In a further aspect, the invention provides a computer program product, in particular in the form of a non-volatile data store and/or a signal sequence, comprising program code that, when loaded and executed in a computer system, causes it to perform a method according to the present invention, in particular in one of the preferred embodiments described herein.

Further preferred details in the implementation of the invention will be described below with reference to the accompanying figures with reference to preferred embodiments. The figures show:

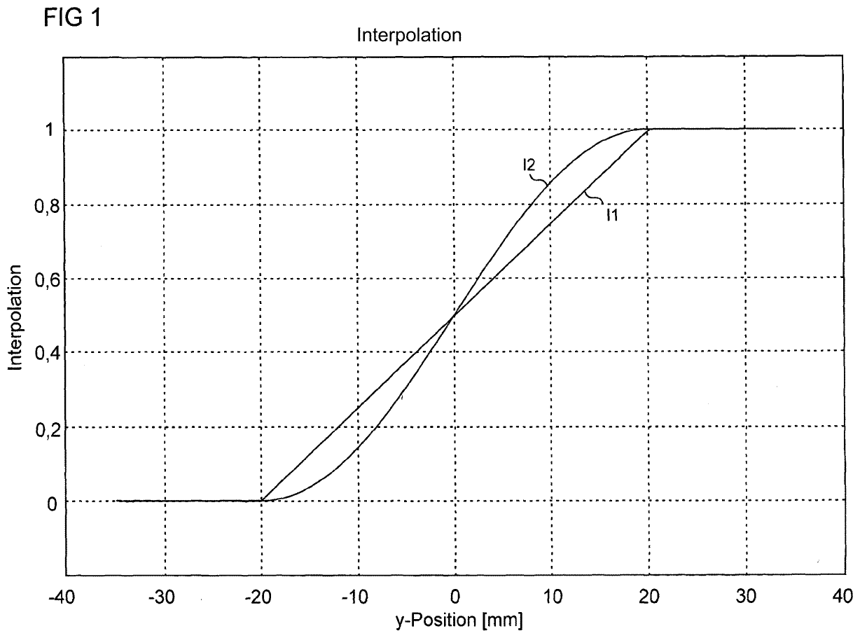

FIG. 1: a schematic representation of the profile of exemplary interpolation functions for a possible determination of a target color function, as may be used in connection with the present invention;

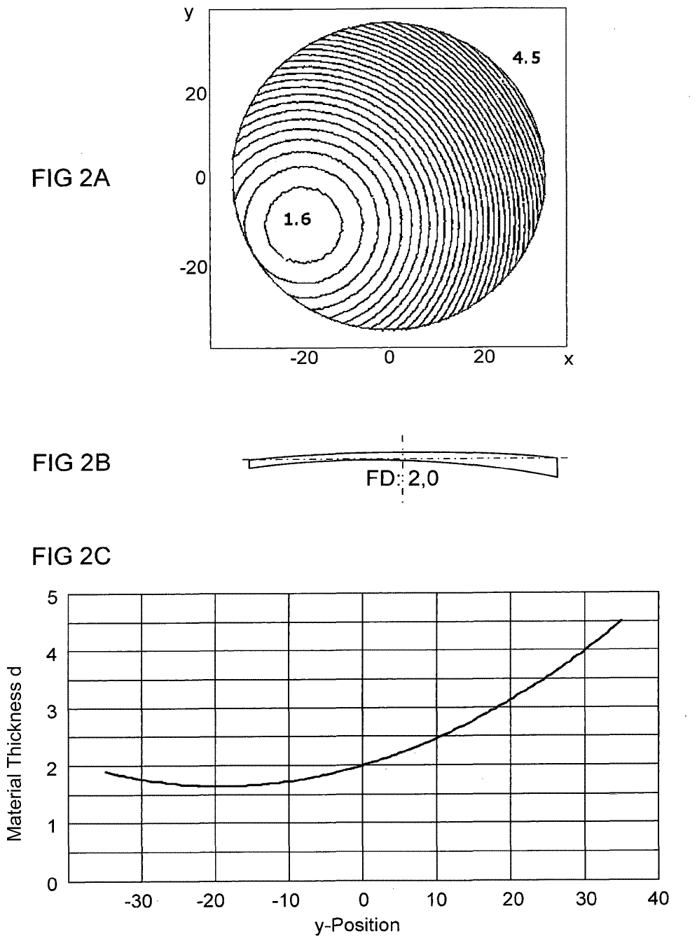

FIG. 2A: an exemplary distribution of the material thickness as a function of the location of a prismatic glass;

FIG. 2B: a sectional view taken along the horizontal axis (x axis) through the center (y=0) of the glass of FIG. 2A;

FIG. 2C: a profile of the material thickness for a section according to FIG. 2B along the x axis with y=0;

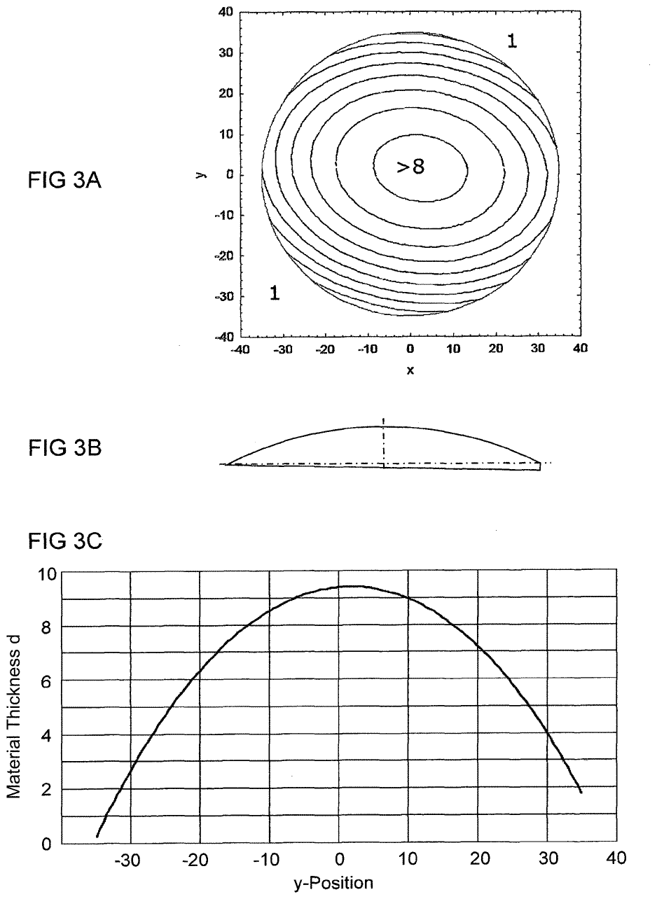

FIG. 3A: an exemplary distribution of material thickness as a function of the location of a cylindrical glass;

FIG. 3B: a sectional view taken along the vertical axis (y axis) through the center (x=0) of the glass of FIG. 3A; and

FIG. 3C: a profile of the material thickness for a section according to FIG. 3B along the y axis with x=0.

In the case of materials that possess a thickness-dependent intrinsic coloration, it is possible to set a target coloration or a spatially resolved target coloration function by targeted spatially resolved counter-coloring. With this method, it is possible to obtain colorations independent of the material thickness.

In principle, the present invention can be used with all coloring techniques that enable spatially resolved coloring. For example, with the following known coloring techniques, it is possible to obtain a targeted spatially resolved counter-coloring for the use of the present invention:

As a suitable coloring technique, mention is to be made of the Nidek method (e.g., EP0982432B1, EP1905890A2, EP1992734B1, EP2261419B1, EP2532781B1):
printing sublimation ink on special sublimation paper,
transferring the color from the sublimation paper to the spectacle lens surface in a vacuum oven by thermal heating,
tempering the glass to diffuse the color into the glass surface.

In addition, a coloring technique known from EP1683645B1 is suitable (Essilor method):
coating a glass with a primer film;
drying the primer film;
applying a porous color-sensitive film;
applying ink (inkjet process);
tempering the glass to diffuse the color into the glass surface;
removing the porous color-sensitive film.

Similar coloring techniques (e.g., Itoh method) are suitable as well.

Further coloring techniques are known from EP2319981B1 and EP2460666B1 (in some cases special high-index polymers that allow coloring):
applying a CAB (cellulose acetate butyrate) layer;
drying the CAB layer;
printing of sublimation ink;
tempering the glass to diffuse the color into the glass surface;
removing the CAB layer.

Classical coloring by means of dip dyeing baths is basically possible, but the flexibility in spatially resolved color correction is very limited.

Preferably, the glass material used is first of all characterized with regard to its optical properties. This is preferably done via a material-specific intrinsic coloration vector

\vec{F}(d):=\vec{F₀}+d·\vec{D} equation (1),

which is made up of a surface percentage

$$\vec{{F}_{0}} \text{:} = ( \begin{matrix}{T}_{0} \\ {a}_{0}^{*} \\ {b}_{0}^{*}\end{matrix} ) \qquad equation ( 2 )$$

and a volume percentage

$$\vec{D} \text{:} = ( \begin{matrix}Δ T \\ Δ {a}^{*} \\ Δ {b}^{*}\end{matrix} ) \qquad equation ( 3 )$$

the intrinsic coloration as a function of the material thickness d. The representation of the intrinsic coloration as a vector takes place in the selected, and essentially freely selectable, color space. In the following, the L*a*b* color space (CIELAB) is chosen as an example. However, the invention could also be used with other color space models, e.g. RGB color space, CMYK color space, etc.

Three examples of possible glass materials are mentioned below:

Material #1:

$$\begin{matrix}Surface percentage \text{:} \vec{{F}_{0}^{\#1}} : = ( \begin{matrix}92.06 \\ 0.02 \\ 0.31\end{matrix} ) & equation ( 4 ) \\ Volume percentage \text{:} \vec{{D}^{\#1}} : = ( \begin{matrix}- 0.974 \\ - 0.060 \\ - 0.114\end{matrix} ) & equation ( 5 )\end{matrix}$$

Material #2:

$$\begin{matrix}Surface percentage \text{:} \vec{{F}_{0}^{\#2}} \text{:} = ( \begin{matrix}94.83 \\ - 0.35 \\ 1.13\end{matrix} ) & equation ( 6 ) \\ Volume percentage \text{:} \vec{{D}^{\#2}} \text{:} = ( \begin{matrix}- 0.252 \\ - 0.141 \\ 0.228\end{matrix} ) & equation ( 7 )\end{matrix}$$

Material #3:

$$\begin{matrix}Surface percentage \text{:} \vec{{F}_{0}^{\#3}} \text{:} = ( \begin{matrix}94.84 \\ - 0.46 \\ 1.34\end{matrix} ) & equation ( 8 ) \\ Volume percentage \text{:} \vec{{D}^{\#3}} \text{:} = ( \begin{matrix}- 0.193 \\ - 0.384 \\ - 0.600\end{matrix} ) & equation ( 9 )\end{matrix}$$

With a reference value for the thickness: d_{Ref}=8 mm (thickness of a reference substrate of the corresponding material), the intrinsic coloration of the reference substrate results:

Material #1:

$$\vec{{F}_{8}^{\#1}} \text{:} = ( \begin{matrix}84.26 \\ - 0.47 \\ - 0.60\end{matrix} ) \qquad equation ( 10 )$$

Material #2:

$$\vec{{F}_{8}^{\#2}} \text{:} = ( \begin{matrix}92.82 \\ - 1.48 \\ 2.95\end{matrix} ) \qquad equation ( 11 )$$

Material #3:

$$\vec{{F}_{8}^{\#3}} \text{:} = ( \begin{matrix}92.30 \\ - 3.53 \\ 6.14\end{matrix} ) \qquad equation ( 12 )$$

Preferably, at least one target coloration of the glass is determined in the same color space. Distributed across the glass, i.e. in each visual point, this may be the same target coloration. However, the target coloration may also be determined as a color gradient (e.g., stronger or darker coloration at the top than at the bottom). The target coloration constitutes the color tone in which the entire, colored glass should appear at the end. The representation takes place in a selected color space.

### EXAMPLE (1)

$$\vec{{Z}_{z , 1}} \text{:} = ( \begin{matrix}{L}_{1}^{*} \\ {a}_{1}^{*} \\ {b}_{1}^{*}\end{matrix} ) = ( \begin{matrix}49.57 \\ - 0.51 \\ 0.59\end{matrix} ) \qquad equation ( 13 )$$

This coloring vector \vec{Z_{z,1}} of the target coloration is to be valid for all evaluation points on the glass (homogeneous target coloration) in example (1). Thus, no location-dependent definition of the target coloration \vec{Z_{z,1}} is necessary.

In the case of a two-color glass (bicolor glass), preferably two visual points (evaluation points) are initially defined especially in a 2-dimensional Cartesian coordinate system, the zero point of which is e.g. in the circle center of the (uncut) glass. The glass is preferably oriented such that the cx side is perpendicular to the x-y plane and the zero angle points to the right. This corresponds to the definition according to the so-called TABO degree scheme.

A first local target coloration for the visual point at the top (first or top reference point) is defined at the location:

$$\vec{{V}_{O}} := ( \begin{matrix}{V}_{x O} \\ {V}_{y O}\end{matrix} ) \qquad equation ( 14 )$$

and the associated first local target coloration vector by:

$$\vec{{Z}_{O , z}} := ( \begin{matrix}{L}_{O}^{*} \\ {a}_{O}^{*} \\ {b}_{O}^{*}\end{matrix} ) = ( \begin{matrix}72 , 73 \\ 2 , 54 \\ 10 , 89\end{matrix} ) \qquad equation ( 15 )$$

A second local target coloration for the visual point at the bottom (second or bottom reference point) is defined at the location:

$$\vec{{V}_{U}} := ( \begin{matrix}{V}_{x U} \\ {V}_{y U}\end{matrix} ) \qquad equation ( 16 )$$

and the associated second local target color vector by:

$$\vec{{Z}_{U , z}} := ( \begin{matrix}{L}_{U}^{*} \\ {a}_{U}^{*} \\ {b}_{U}^{*}\end{matrix} ) = ( \begin{matrix}82 , 72 \\ - 2 , 13 \\ 2 , 33\end{matrix} ) \qquad equation ( 17 )$$

By specifying a target color function

$$\vec{{Z}_{z}} ( x , y ) := ( \begin{matrix}{L}^{*} ( x , y ) \\ {a}^{*} ( x , y ) \\ {b}^{*} ( x , y )\end{matrix} ) \qquad equation ( 18 )$$

a local target coloration can be defined for each position on the glass.

### EXAMPLE (2)

$$\begin{matrix}\vec{{V}_{O}} := ( \begin{matrix}0 \\ {V}_{y O}\end{matrix} ) & equation ( 19 ) \\ with \\ {V}_{y O} = + 20 , 0 mm \\ and & equation ( 20 ) \\ \vec{{V}_{U}} := ( \begin{matrix}0 \\ {V}_{y U}\end{matrix} ) \\ and & equation ( 21 ) \\ {V}_{y U} = - 20 , 0 mm & equation ( 22 )\end{matrix}$$

In principle, arbitrary functions that best describe the desired color density distribution can be defined as the interpolation function. As a linear interpolation, for example, the function

$${I}_{1} ( y ) := \{ \begin{matrix}0 & & y < {V}_{yU} \\ \frac{y - {V}_{y U}}{{V}_{yO} - {V}_{y U}} & f \ddot{u} r & {V}_{yU} \leq y \leq {V}_{yO} \\ 1 & & y > {V}_{yO}\end{matrix} \qquad equation ( 23 )$$

can be chosen. Less hard transitions are obtained, for example, by the following interpolation.

$${I}_{2} ( y ) : = \{ \begin{matrix}0 & & y < {V}_{y U} \\ \frac{1}{2} \cdot ( 1 + sin ( ( 2 \cdot \frac{y - {V}_{y U}}{{V}_{yO} - {V}_{y U}} - 1 ) \frac{π}{2} ) ) & f \ddot{u} r & {V}_{y U} \leq y \leq {V}_{yO} \\ 1 & & y > {V}_{yO}\end{matrix} \qquad equation ( 24 )$$

For example (2), the target color function is thus defined by:

\vec{Z_{z}}(\vec{x}):=\vec{Z_{z}}(y)·\vec{Z}_{O,z}+(1−I₁(y))·\vec{Z_{U,z}} equation (25)

or for softer transitions by:

\vec{Z_{z}}(\vec{x}):=\vec{Z_{z}}(y)=I₂(y)·\vec{Z_{O,z}}+(1−I₂(y))·\vec{Z_{U,z}} equation (26)

The following describes, by way of example, how the location-dependent coloring is preferably carried out. In a preferred embodiment, three color pigments are used to set the target coloration. This may be three different color pigments of the types red, yellow, blue, but also e.g. color pigments of the types orange, yellow, and blue. In another preferred embodiment, four different color pigments are used, e.g. red, orange, yellow, blue. In specific embodiments, it may also be sufficient to use only two different color pigments or even just one type of color pigment. For the sake of simplicity, it is assumed here by way of example that a three-color pigment system with the pigment colors red, yellow and blue is present.

If a pigment system has been specified, the amount of pigment used can be defined by a pigment amount vector

$$\vec{P} : = ( \begin{matrix}{P}_{Red} \\ {P}_{Y e l l o w} \\ {P}_{B l u e}\end{matrix} ) \qquad equation ( 27 )$$

Preferably, the units of P_{Red}, P_{Yellow} and P_{Blue} are indicated in %, where 100% represents a color pigment reference amount specified once for the respective color pigment.

In order to obtain a target coloration \vec{Z_{z}}, a reference color pigment amount \vec{Pᵣ} can be specified for a material and a thickness d of a reference substrate. The values of \vec{Pᵣ} are preferably determined experimentally.

### EXAMPLE (1)

Material #3, thickness d=1.5 mm, homogeneous coloration:

$$\begin{matrix}\vec{{Z}_{z 1}} := ( \begin{matrix}49 , 57 \\ - 0 , 51 \\ 0 , 59\end{matrix} ) & equation ( 28 ) \\ \vec{{P}_{r , 1}} = ( \begin{matrix}38 , 21 \% \\ 48 , 29 \% \\ 58 , 97 \%\end{matrix} ) & equation ( 29 )\end{matrix}$$

### EXAMPLE (2)

Material #3, thickness d=1.5 mm, location-dependent coloration at the top:

$$\begin{matrix}\vec{{Z}_{O , z}} := ( \begin{matrix}72 , 73 \\ 2 , 54 \\ 10 , 89\end{matrix} ) & equation ( 30 ) \\ \vec{{P}_{O , r}} = ( \begin{matrix}18 , 16 \% \\ 34 , 08 \% \\ 6 , 30 \%\end{matrix} ) & equation ( 31 )\end{matrix}$$

Material #3, thickness d=1.5 mm, location-dependent coloration at the bottom:

$$\begin{matrix}\vec{{Z}_{U , z ,}} := ( \begin{matrix}82 , 72 \\ - 2 , 13 \\ 2 , 33\end{matrix} ) & equation ( 32 ) \\ \vec{{P}_{U , r}} = ( \begin{matrix}1 , 74 \% \\ 6 , 77 \% \\ 6 , 26 \%\end{matrix} ) & equation ( 33 )\end{matrix}$$

In the vicinity of the target coloration \vec{Z_{z}}, the change of the color pigments (\vec{P}−\vec{Pᵣ}) can be described based on the deviation of the color change \vec{Z}−\vec{Z_{z}}. Preferably, the coloration in this environment is described by the linear relationship:

\vec{P}=\vec{Pᵣ}+ [symbol] ·(\vec{Z}−\vec{Z_{z}}) (equation (34)

In this equation, [symbol] is preferably a 3×3 matrix whose entries are preferably determined experimentally. In particular, matrix entries have the unit of color % per L*a*b* unit. This pigment amount correction matrix [symbol] can be specified once for each desired target coloration, in particular independently of the glass material selected in the individual case and the specific glass thickness (i.e. independently of an intrinsic coloration of the glass body).

### EXAMPLE (1)

Material #3, homogeneous target coloration \vec{Z_{z,1}}:

$$\vec{M} : = ( \begin{matrix}- 0 , 389 & - 0 , 524 & - 0 , 589 \\ 0 , 289 & - 0 , 145 & - 0 , 488 \\ 0 , 118 & 0 , 677 & - 0 , 243\end{matrix} ) \qquad equation ( 35 )$$

### EXAMPLE (2)

Material #3, target coloration at the top \vec{Z_{O,z}}:

$$\vec{{M}_{O}} : = ( \begin{matrix}- 0 , 279 & - 0 , 375 & - 0 , 388 \\ 0 , 276 & - 0 , 137 & - 0 , 462 \\ 0 , 074 & 0 , 608 & - 0 , 226\end{matrix} ) \qquad equation ( 36 )$$

Material #3, target coloration at the bottom \vec{Z_{U,z}}:

$$\vec{{M}_{U}} : = ( \begin{matrix}- 0 , 256 & - 0 , 323 & - 0 , 389 \\ 0 , 282 & - 0 , 111 & - 0 , 441 \\ 0 , 104 & 0 , 544 & - 0 , 235\end{matrix} ) \qquad equation ( 37 )$$

In order to determine a suitable color correction for a glass to be colored, first the specific intrinsic coloration of the glass material is determined. FIG. 2A illustrates a thickness profile of a first exemplary prismatic glass. The lines represent the course of constant thicknesses. FIG. 2B illustrates a cross-section through the glass along the x axis with y=0 (i.e., through the center of the uncut glass). In general, the material thickness d is a function of the location d(\vec{x}). In FIG. 2C, for the first exemplary glass, the thickness is given as a function of location along the section of FIG. 2B. The following table shows the material thicknesses for this section at position x in 5 mm increments:

TABLE 1
Material thicknesses for a section along the x axis
with y = 0 in 5 mm increments.

| x [mm] | d [mm] |
|---|---|
| −35 | 1.9 |
| −30 | 1.76 |
| −25 | 1.68 |
| −20 | 1.65 |
| −15 | 1.66 |
| −10 | 1.73 |
| −5 | 1.84 |
| 0 | 2 |
| 5 | 2.21 |
| 10 | 2.47 |
| 15 | 2.77 |
| 20 | 3.13 |
| 25 | 3.54 |
| 30 | 3.99 |
| 35 | 4.5 |

Further, in this example, it is assumed that the material #3 is used.

Thus, for the thickness-dependent intrinsic coloration \vec{D}=\vec{D^{#3}}, equation (9) is applicable. The location-dependent color shift experienced by the glass is thus:

Δ\vec{F}(\vec{x})=d(\vec{x})·\vec{D} equation (38)

Thus, the color shift along the x axis is given by the following table values:

TABLE 2
Material thicknesses and the color shift ΔL*, Δa*, Δb* when using
the material # 3 for a section along the x axis with y = 0 in 5 mm
increments. The reference thickness of the color shift is in this
case 1.5 mm, for example.

| x [mm] | d [mm] | ΔL* | Δa* | Δb* |
|---|---|---|---|---|
| −35 | 1.9 | −0.077 | −0.154 | 0.240 |
| −30 | 1.76 | −0.050 | −0.100 | 0.156 |
| −25 | 1.68 | −0.035 | −0.069 | 0.108 |
| −20 | 1.65 | −0.029 | −0.058 | 0.090 |
| −15 | 1.66 | −0.031 | −0.061 | 0.096 |
| −10 | 1.73 | −0.044 | −0.088 | 0.138 |
| −5 | 1.84 | −0.066 | −0.131 | 0.204 |
| 0 | 2 | −0.097 | −0.192 | 0.300 |
| 5 | 2.21 | −0.137 | −0.273 | 0.426 |
| 10 | 2.47 | −0.187 | −0.372 | 0.582 |
| 15 | 2.77 | −0.245 | −0.488 | 0.762 |
| 20 | 3.13 | −0.315 | −0.626 | 0.978 |
| 25 | 3.54 | −0.394 | −0.783 | 1.224 |
| 30 | 3.99 | −0.481 | −0.956 | 1.494 |
| 35 | 4.5 | −0.580 | −1.152 | 1.800 |

In order to at least partially compensate for this color shift, the surface color is now corrected on the glass front and/or on the glass back in particular by a linear combination of front and back such that the target coloration is obtained at least approximately. As target coloration, the target coloration specified in Example (1) is to be obtained here. The overall coloration in transmission is thus independent of the glass thickness and, in the case of a homogeneous coloration, independent of the position \vec{x} on the glass. For each position on the glass, the color pigment amount can be specified in order to obtain the target coloration at this location, regardless of the pre-coloration.

Equations (29), (35) and (38) yield for Example (1):

\vec{P_{z}}(\vec{x}):=\vec{Pᵣ}− [symbol] ·Δ\vec{F}(\vec{x}) equation (39).

This results in the following color pigment amounts for the material #3 in the coloration according to Example (1) for a section along the x axis with y=0 in 5 mm increments:

TABLE 3
Material thicknesses and color pigment amounts Red [%], Yellow [%]
and Blue [%] for material # 3 and coloration according to Example (1)
for a section along the x axis with y = 0 in 5 mm increments.

| x [mm] | d [mm] | Red [%] | Yellow [%] | Blue [%] |
|---|---|---|---|---|
| −35 | 1.9 | 38.24 | 48.41 | 59.15 |
| −30 | 1.76 | 38.23 | 48.37 | 59.09 |
| −25 | 1.68 | 38.23 | 48.34 | 59.05 |
| −20 | 1.65 | 38.23 | 48.33 | 59.04 |
| −15 | 1.66 | 38.23 | 48.34 | 59.04 |
| −10 | 1.73 | 38.23 | 48.36 | 59.07 |
| −5 | 1.84 | 38.24 | 48.39 | 59.12 |
| 0 | 2 | 38.25 | 48.44 | 59.19 |
| 5 | 2.21 | 38.27 | 48.50 | 59.28 |
| 10 | 2.47 | 38.29 | 48.58 | 59.39 |
| 15 | 2.77 | 38.31 | 48.66 | 59.52 |
| 20 | 3.13 | 38.34 | 48.77 | 59.67 |
| 25 | 3.54 | 38.37 | 48.89 | 59.85 |
| 30 | 3.99 | 38.41 | 49.02 | 60.04 |
| 35 | 4.5 | 38.44 | 49.18 | 60.26 |

FIG. 3A illustrates a thickness profile of a second exemplary cylindrical glass with high +power. The lines represent the course of constant thicknesses. FIG. 3B illustrates a cross-section through the second exemplary glass along the y axis with x=0 (i.e., through the center of the uncut glass). In general, the material thickness d is a function of the location d(\vec{x}). In FIG. 3C, for the second exemplary glass, the thickness is given as a function of location along the section of FIG. 3B. The following table shows the material thicknesses for this section in 5 mm increments:

TABLE 4
Material thicknesses for a section along the y axis with x = 0
in 5 mm increments.

| y [mm] | d [mm] |
|---|---|
| −35 | 0.25 |
| −30 | 2.69 |
| −25 | 4.71 |
| −20 | 6.34 |
| −15 | 7.61 |
| −10 | 8.53 |
| −5 | 9.13 |
| 0 | 9.4 |
| 5 | 9.35 |
| 10 | 8.97 |
| 15 | 8.26 |
| 20 | 7.21 |
| 25 | 5.8 |
| 30 | 4 |
| 35 | 1.78 |

As in the previous example, in this example, it is assumed below that the material #3 is used. Thus, for the thickness-dependent intrinsic coloration \vec{D}=\vec{D^{#3}}, equation (9) is applicable. The location-dependent color shift experienced by the glass is thus defined by equation (38):

Δ\vec{F}(\vec{x})=d(\vec{x})·\vec{D}

Thus, the color shift along the y axis is given by the following table values:

TABLE 5
Material thicknesses and the color shift ΔL*, Δa*, Δb* when using
the material # 3 for a section along the y axis with x = 0 in 5 mm
increments. The reference thickness of the color shift is in this case
1.5 mm, for example.

| Y [mm] | d [mm] | ΔL* | Δa* | Δ* |
|---|---|---|---|---|
| −35 | 0.25 | 0.242 | 0.480 | −0.750 |
| −30 | 2.69 | −0.230 | −0.457 | 0.714 |
| −25 | 4.71 | −0.620 | −1.232 | 1.926 |
| −20 | 6.34 | −0.935 | −1.858 | 2.904 |
| −15 | 7.61 | −1.181 | −2.346 | 3.666 |
| −10 | 8.53 | −1.358 | −2.699 | 4.218 |
| −5 | 9.13 | −1.474 | −2.929 | 4.578 |
| 0 | 9.4 | −1.526 | −3.033 | 4.740 |
| 5 | 9.35 | −1.517 | −3.014 | 4.710 |
| 10 | 8.97 | −1.443 | −2.868 | 4.482 |
| 15 | 8.26 | −1.306 | −2.595 | 4.056 |
| 20 | 7.21 | −1.103 | −2.192 | 3.426 |
| 25 | 5.8 | −0.831 | −1.651 | 2.580 |
| 30 | 4 | −0.483 | −0.960 | 1.500 |
| 35 | 1.78 | −0.054 | −0.108 | 0.168 |

Now, the surface coloration is corrected either on the glass front or on the glass back or a linear combination of front and back, in order to approximate the overall coloration as well as possible to the desired target coloration. Since in the example described here, a bicolor coloration according to the target coloration given above as Example (2) is to be obtained, it is first assumed that this target coloration can be described starting from two homogeneous plain colorations. For each position on the glass, the color pigment amount of the coloration at the top (0) and at the bottom (U) can now be specified.

The equations (31), (36) and (38) yield for Example (2) for the upper target color pigment amount:

\vec{P_{O,z}}(\vec{x}):=\vec{P_{O,r}}− [symbol] ·Δ\vec{F}(\vec{x}) equation (40).

The equations (33), (37) and (38) yield for Example (2) for the lower target color pigment amount:

\vec{P_{U,z}}(\vec{x}):=\vec{P_{U,r}}− [symbol] ·Δ\vec{F}(\vec{x}) equation (41).

For the color pigment amounts of the two partial colorations, the following values result along the y axis (at x=0):

TABLE 6
Material Thicknesses and color pigment amounts Red[%], Yellow[%]
and Blue[%] for Material # 3 and coloration at the top and
coloration at the bottom for a section along the y axis with x = 0 in 5 mm increments.

| | | Top | | | Bottom | | |
|---|---|---|---|---|---|---|---|
| Y[mm] | d[mm] | Red[%] | Yellow[%] | Blue[%] | Red[%] | Yellow[%] | Blue[%] |
| −35 | 0.25 | 18.11 | 34.20 | 6.45 | 1.67 | 6.88 | 6.41 |
| −30 | 2.69 | 18.20 | 34.16 | 6.40 | 1.82 | 6.84 | 6.35 |
| −25 | 4.71 | 18.27 | 34.13 | 6.37 | 1.94 | 6.82 | 6.32 |
| −20 | 6.34 | 18.33 | 34.13 | 6.35 | 2.03 | 6.81 | 6.31 |
| −15 | 7.61 | 18.37 | 34.13 | 6.36 | 2.11 | 6.82 | 6.32 |
| −10 | 8.53 | 18.40 | 34.15 | 6.38 | 2.16 | 6.83 | 6.34 |
| −5 | 9.13 | 18.43 | 34.18 | 6.43 | 2.20 | 6.86 | 6.38 |
| 0 | 9.4 | 18.44 | 34.22 | 6.49 | 2.22 | 6.91 | 6.44 |
| 5 | 9.35 | 18.43 | 34.28 | 6.57 | 2.21 | 6.97 | 6.52 |
| 10 | 8.97 | 18.42 | 34.35 | 6.67 | 2.19 | 7.04 | 6.62 |
| 15 | 8.26 | 18.39 | 34.44 | 6.78 | 2.15 | 7.12 | 6.73 |
| 20 | 7.21 | 18.36 | 34.54 | 6.92 | 2.09 | 7.22 | 6.86 |
| 25 | 5.8 | 18.31 | 34.65 | 7.08 | 2.00 | 7.33 | 7.01 |
| 30 | 4 | 18.24 | 34.77 | 7.25 | 1.89 | 7.46 | 7.18 |
| 35 | 1.78 | 18.17 | 34.92 | 7.45 | 1.76 | 7.60 | 7.37 |

Analogous to the interpolation formula for the interpolated target colorations of equations (25) and (26), the color pigment amounts can be interpolated as well.

\vec{P_{z}}(\vec{x}):=\vec{P_{z}}(y)=I₂(y)·\vec{P_{O,z}}+(1−I₂(y))·\vec{P_{U,z}} equation (42)

The color pigment amount of the upper (first) partial coloration can thus be specified as follows:

TABLE 7
Percentage of color pigments from the Percentage Top

| | Top | | | | Percentage Top | | |
|---|---|---|---|---|---|---|---|
| Y[mm] | Red[%] | Yellow[%] | Blue[%] | I2 | Red[%] | Yellow[%] | Blue[%] |
| −35 | 18.11 | 34.20 | 6.45 | 0.000 | 0.00 | 0.00 | 0.00 |
| −30 | 18.20 | 34.16 | 6.40 | 0.000 | 0.00 | 0.00 | 0.00 |
| −25 | 18.27 | 34.13 | 6.37 | 0.000 | 0.00 | 0.00 | 0.00 |
| −20 | 18.33 | 34.13 | 6.35 | 0.000 | 0.00 | 0.00 | 0.00 |
| −15 | 18.37 | 34.13 | 6.36 | 0.038 | 0.70 | 1.30 | 0.24 |
| −10 | 18.40 | 34.15 | 6.38 | 0.146 | 2.70 | 5.00 | 0.94 |
| −5 | 18.43 | 34.18 | 6.43 | 0.309 | 5.69 | 10.55 | 1.98 |
| 0 | 18.44 | 34.22 | 6.49 | 0.500 | 9.22 | 17.11 | 3.24 |
| 5 | 18.43 | 34.28 | 6.57 | 0.691 | 12.74 | 23.70 | 4.54 |
| 10 | 18.42 | 34.35 | 6.67 | 0.854 | 15.72 | 29.32 | 5.69 |
| 15 | 18.39 | 34.44 | 6.78 | 0.962 | 17.69 | 33.13 | 6.52 |
| 20 | 18.36 | 34.54 | 6.92 | 1.000 | 18.36 | 34.54 | 6.92 |
| 25 | 18.31 | 34.65 | 7.08 | 1.000 | 18.31 | 34.65 | 7.08 |
| 30 | 18.24 | 34.77 | 7.25 | 1.000 | 18.24 | 34.77 | 7.25 |
| 35 | 18.17 | 34.92 | 7.45 | 1.000 | 18.17 | 34.92 | 7.45 |

The color pigment amount of the lower (second) partial coloration can thus be specified as follows:

TABLE 8
Percentage of color pigments from the Percentage Bottom

| | Bottom | | | | Percentage Bottom | | |
|---|---|---|---|---|---|---|---|
| Y[mm] | Red[%] | Yellow[%] | Blue[%] | 1.0 -I2 | Red[%] | Yellow[%] | Blue[%] |
| −35 | 1.67 | 6.88 | 6.41 | 1.000 | 1.67 | 6.88 | 6.41 |
| −30 | 1.82 | 6.84 | 6.35 | 1.000 | 1.82 | 6.84 | 6.35 |
| −25 | 1.94 | 6.82 | 6.32 | 1.000 | 1.94 | 6.82 | 6.32 |
| −20 | 2.03 | 6.81 | 6.31 | 1.000 | 2.03 | 6.81 | 6.31 |
| −15 | 2.11 | 6.82 | 6.32 | 0.962 | 2.03 | 6.56 | 6.08 |
| −10 | 2.16 | 6.83 | 6.34 | 0.854 | 1.85 | 5.83 | 5.41 |
| −5 | 2.20 | 6.86 | 6.38 | 0.691 | 1.52 | 4.75 | 4.41 |
| 0 | 2.22 | 6.91 | 6.44 | 0.500 | 1.11 | 3.45 | 3.22 |
| 5 | 2.21 | 6.97 | 6.52 | 0.309 | 0.68 | 2.15 | 2.01 |
| 10 | 2.19 | 7.04 | 6.62 | 0.146 | 0.32 | 1.03 | 0.97 |
| 15 | 2.15 | 7.12 | 6.73 | 0.038 | 0.08 | 0.27 | 0.26 |
| 20 | 2.09 | 7.22 | 6.86 | 0.000 | 0.00 | 0.00 | 0.00 |
| 25 | 2.00 | 7.33 | 7.01 | 0.000 | 0.00 | 0.00 | 0.00 |
| 30 | 1.89 | 7.46 | 7.18 | 0.000 | 0.00 | 0.00 | 0.00 |
| 35 | 1.76 | 7.60 | 7.37 | 0.000 | 0.00 | 0.00 | 0.00 |

TABLE 9
Overall color pigment amounts Red [%], Yellow [%] and Blue [%]
for material # 3 and coloration 1 (Example (1)) for a section along the
y axis with x = 0 in 5 mm increments.

| | Overall | | |
|---|---|---|---|
| Y [mm] | Red [%] | Yellow [%] | Blue [%] |
| −35 | 1.67 | 6.88 | 6.41 |
| −30 | 1.82 | 6.84 | 6.35 |
| −25 | 1.94 | 6.82 | 6.32 |
| −20 | 2.03 | 6.81 | 6.31 |
| −15 | 2.73 | 7.85 | 6.32 |
| −10 | 4.54 | 10.83 | 6.35 |
| −5 | 7.21 | 15.30 | 6.40 |
| 0 | 10.33 | 20.57 | 6.47 |
| 5 | 13.43 | 25.85 | 6.55 |
| 10 | 16.04 | 30.35 | 6.66 |
| 15 | 17.78 | 33.40 | 6.78 |
| 20 | 18.36 | 34.54 | 6.92 |
| 25 | 18.31 | 34.65 | 7.08 |
| 30 | 18.24 | 34.77 | 7.25 |
| 35 | 18.17 | 34.92 | 7.45 |

Although preferred embodiments have been described by way of example with reference to a color space vector in the L*a*b* color space and by coloring with color pigments of the types red, yellow and blue, the invention is not limited to this color space representation or the color pigment selection described by way of example. Instead, the invention can also be applied analogously in other color space models and with other basic colors. The invention is not limited to the use of 3 basic colors. In particular, the invention is also applicable to coloring processes in which the target coloration is obtained with 4 or more basic colors. In this case, only the dimension of the color pigment amount vector \vec{P} and the pigment amount correction matrix [symbol] are adjusted accordingly. If the material and three colors are given, the result is always clear. If, for example, a color pigment or a mixture of color pigments representing an exact compensation of the counter-coloration is provided, then the problem simplifies to local counter-coloring by means of color or of the color mixture. The disadvantage of such a firmly defined color mixture is that possible adjustments are not possible afterward. However, this method does without an adjustment color.

1-14. (canceled)

15. A method of coloring a spectacle lens, which includes a predetermined glass material, for obtaining a target coloration of the optical glass, the method comprising:
determining a material-specific intrinsic coloration of the predetermined glass material;
determining a glass thickness at a plurality of evaluation points on the optical glass;
identifying an intrinsic coloration of the optical glass from the material-specific intrinsic coloration of the predetermined glass material and the glass thickness at the plurality of evaluation points on the optical glass;
determining a reference color pigment amount for at least one color pigment such that the reference color pigment amount, applied to a reference substrate, causes the target coloration to be obtained on the optical glass for the reference substrate;
specifying a color correction model describing a relationship between a deviation of a color pigment amount for at least one color pigment from the reference color pigment amount of the at least one color pigment and a resulting deviation of a coloration of the reference substrate from the target coloration; and
determining a target color pigment amount that deviates from the reference color pigment amount by a color pigment amount correction, which compensates for the identified intrinsic coloration of the optical glass according to the specified color correction model.

16. The method according to claim 15, wherein the material of the reference substrate corresponds to the predetermined glass material.

17. The method according to claim 15, wherein the determining a glass thickness at a plurality of evaluation points on the optical glass comprises identifying a deviation Δd of the glass thickness of the optical glass at a plurality of evaluation points on the optical glass from a thickness of the reference substrate, and wherein identifying the intrinsic coloration of the optical glass comprises identifying a deviation Δ\vec{F} of an intrinsic coloration of the optical glass from an intrinsic coloration of the reference substrate on the basis of the identified deviation Δd of the thickness of the optical glass from a thickness of the reference substrate according to
Δ\vec{F}=Δd·\vec{D}
with a volume color vector \vec{D}.

18. The method according claim 17, wherein the specifying a color correction model comprises determining a pigment amount correction matrix [symbol] such that the relationship between a deviation Δ\vec{P}=\vec{P}−\vec{Pᵣ} of a color pigment amount \vec{P} for at least one color pigment from the reference color pigment amount \vec{Pᵣ} of the at least one color pigment and a resulting deviation Δ\vec{Z}=\vec{Z}−\vec{Z_{z}}\vec{ } of a coloration \vec{Z} of the reference substrate from the target coloration \vec{Z_{z}} is described by
Δ\vec{P}= [symbol] ·Δ\vec{Z}

19. The method according to claim 18, wherein the pigment amount correction matrix [symbol] is determined experimentally on the reference substrate.

20. The method according to claim 18, wherein the determining a target color pigment amount \vec{P_{z}} can be performed according to
\vec{P_{z}}=\vec{Pᵣ}− [symbol] ·Δ\vec{F}

21. The method according to claim 15, wherein the determining a glass thickness at a plurality of evaluation points on the optical glass takes place based on data sets of an optical calculation and optimization method at least one glass surface of the optical glass.

22. The method according to claim 15, wherein the target coloration \vec{Z_{z}} to be obtained for the optical glass according to
\vec{Z_{z}}(\vec{x})=I(\vec{x})·\vec{Z_{O,z}}+(1−I(\vec{x}))·\vec{Z_{U,z}}
depends on a position \vec{x} on the optical glass with a first target coloration \vec{Z_{O,z}} to be obtained at a first evaluation point \vec{x_{O}} on the optical glass, a second target coloration \vec{Z_{U,z}} to be obtained at a second evaluation point \vec{x_{U}} on the optical glass, and an interpolation function I(\vec{x}) satisfying I(\vec{x_{O}})=1 and I(\vec{x_{U}})=0, and
wherein the determining a reference color pigment amount comprises:
determining a first reference color pigment amount \vec{P_{O,r}} such that the first reference color pigment amount \vec{P_{O,r}}, applied to the reference substrate, causes the first target coloration \vec{Z_{O,z}} to be obtained on the optical glass for the reference substrate; and
determining a second reference color pigment amount \vec{P_{U,r}} such that the second reference color pigment amount \vec{P_{U,r}}, applied to the reference substrate, causes the second target coloration \vec{Z_{U,z}} to be obtained on the optical glass for the reference substrate.

23. The method according to claim 17, wherein specifying a color correction model comprises:
determining a first pigment amount correction matrix [symbol] such that the relationship between a first deviation Δ\vec{P_{O}}=\vec{P_{O}}−\vec{P_{O,z}} of a first color pigment amount \vec{P_{O}} for at least one color pigment from the first reference color pigment amount \vec{P_{O,r}} of the at least one color pigment and a resulting first deviation Δ\vec{Z_{O}}=\vec{Z_{O}}−\vec{Z_{O,z}} of a first coloration \vec{Z_{O}} of the reference substrate from the first target coloration \vec{Z_{O,z}} is described by
Δ\vec{P_{O}}= [symbol] ·Δ\vec{Z_{O}}
and
determining a second pigment amount correction matrix [symbol] such that the relationship between a deviation Δ\vec{P_{U}}=\vec{P_{U}}−\vec{P_{U,z}} of a second color pigment amount \vec{P_{U}} for at least one color pigment from the second reference color pigment amount \vec{P_{U,r}} of the at least one color pigment and a resulting second deviation Δ\vec{Z_{U}}=\vec{Z_{U}}−\vec{Z_{U,z}} of a second coloration \vec{Z_{U}} of the reference substrate from the second target coloration \vec{Z_{U,z}} is described by
Δ\vec{P_{U}}= [symbol] ·Δ\vec{Z_{U}}

24. The method according to claim 23, wherein the determining a target color pigment amount comprises:
determining a first target color pigment subset \vec{P_{O,k}} according to
\vec{P_{O,z}}=\vec{P_{O}}− [symbol] ·Δ\vec{F};
determining a second target color pigment subset \vec{P_{U,k}} according to
\vec{P_{U,z}}=\vec{P_{U}}− [symbol] ·Δ\vec{F};
and
determining the target color pigment amount \vec{P_{z}} according to
\vec{P_{z}}=I(\vec{x})·\vec{P_{O,z}}+(1−I(\vec{x}))·\vec{P_{U,z}}.

25. The method according to claim 15, further comprising applying the target color pigment amount to at least one surface of the optical glass.

26. A coloring system for coloring a spectacle lens, which includes a predetermined glass material, for obtaining a target coloration of the optical glass, the system comprising:
a glass material data determiner configured to determine a material-specific intrinsic coloration of the predetermined glass material;
a glass thickness determiner configured to determine a glass thickness at a plurality of evaluation points on the optical glass;
an intrinsic coloration identifier configured to identify an intrinsic coloration of the optical glass from the material-specific intrinsic coloration of the predetermined glass material and the glass thickness at the plurality of evaluation points on the optical glass;
a reference determiner configured to determine a reference color pigment amount for at least one color pigment such that the reference color pigment amount, applied to a reference substrate, causes the target coloration to be obtained on the optical glass for the reference substrate;
a color correction model configured to specify a color correction model that describes a relationship between a deviation of a color pigment amount for at least one color pigment from the reference color pigment amount of the at least one color pigment and a resulting deviation of a coloration of the reference substrate from the target coloration; and
a target color pigment amount determiner configured to determine a target color pigment amount that deviates from the reference color pigment amount by a color pigment amount correction, which compensates for the identified intrinsic coloration of the optical glass according to the specified color correction model.

27. The coloring system according to claim 26, further comprising a color pigment application configured to apply the target color pigment amount to at least one surface of the optical glass.

28. A non-transitory computer program product comprising program code that, when loaded and executed in a computer system, causes it to perform a method according to claim 15.
